(19) United States
(12) Patent Application Publication
(10) Pub. No.: US 2015/0116832 A1
(43) Pub. Date: Apr. 30, 2015

(54) OPTICAL COMPONENT

(71) Applicant: NIHON DEMPA KOGYO CO., LTD., TOKYO (JP)

(72) Inventors: KEI KAMIUTO, SAITAMA (JP); FUTOSHI ISHII, SAITAMA (JP); MOTOO TAKADA, SAITAMA (JP)

(21) Appl. No.: 14/517,940

(22) Filed: Oct. 20, 2014

(30) Foreign Application Priority Data
Oct. 30, 2013 (JP) 2013-225664
Jul. 16, 2014 (JP) 2014-145496

(51) Int. Cl. G02B 5/28; G02B 27/14; G02B 5/04; G02B 1/00; G02B 3/00

(52) U.S. Cl. CPC G02B 5/286; G02B 1/00; G02B 5/282; G02B 5/283; G02B 3/00; G02B 5/04; G02B 27/141
USPC 359/586

(57) ABSTRACT

An optical component includes an optical substrate and a first band-pass filter disposed on the optical substrate. The first band-pass filter includes a high refractive index layer having a first refractive index, and a low refractive index layer having a second refractive index lower than the first refractive index. The high refractive index layer and the low refractive index layer are layered. An expression (n_{L}×d_{L})/(n_{H}×d_{H})≦0.50 (1) is fulfilled, wherein the first refractive index is n_{H}, the second refractive index is n_{L}, the high refractive index layer has a physical film thickness of d_{H}, and the low refractive index layer has a physical film thickness of d_{L}.

### CROSS REFERENCE TO RELATED APPLICATIONS

This application claims the priority benefit of Japan application serial no. 2013-225664, filed on Oct. 30, 2013 and No. 2014-145496, filed on Jul. 16, 2014. The entirety of the above-mentioned patent applications are hereby incorporated by reference herein and made a part of this specification.

### TECHNICAL FIELD

This disclosure relates to an optical component on a surface of which a band-pass filter is disposed, in particular, to an optical component that reduces incident angle dependence of spectral characteristics.

### DESCRIPTION OF THE RELATED ART

Conventionally, a Charge Coupled Device (CCD) sensor or a Complementary Metal-Oxide Semiconductor (CMOS) sensor, which is a solid imaging device of a digital camcorder and a digital camera or similar camera, has an optical low pass filter installed on the front face of the sensors. The optical low pass filter is made of, for example, a glass substrate or a crystal substrate. An optical low pass filter causes a low frequency component to pass through it, and causes a high frequency component not to pass through it to mainly blur thin patterns with a large luminance difference. For example, the solid imaging device generates an interference fringe (moire) when it images regularly aligned thin patterns, and causes a coloring, which is referred to as a false color (color moire) when the solid imaging device images an outline portion having a large luminance difference, for example, hairs with a backlight. In view of this, for reducing such an interference fringe and a false color, the optical low pass filter slightly blurs an image to unsharp edges, and removes interference fringes and the false colors.

Also, such the optical low pass filter has a band-pass filter disposed on, for example, the surface of the optical low pass filter. The band-pass filter removes, for example, an infrared ray to pass components in visible light region only, which can be viewed by human, in order to make a view of solid imaging device having good infrared sensitivity close to a human view.

As an example of such an optical low pass filter, for example, Japanese Unexamined Patent Application Publication No. 2011-158909 discloses a following optical low pass filter. First, the disclosed optical low pass filter includes a plate-shaped crystal substrate, on the surface of which an oxide having a high refractive index, and an oxide having a low refractive index are layered, and then finally a non-oxide having a low refractive index is layered. Then, the optical low pass filter includes, for example, a titanium dioxide (TiO₂) as a material having a high refractive index, and a silicon dioxide (SiO₂) as a material having a low refractive index. These high refractive materials and low refractive materials are layered from 20 times to 60 times, then a magnesium fluoride (MgF₂) is layered as the final layer.

However, a conventional optical low pass filter including a band-pass filter, which is disposed on the surface of a crystal substrate, disadvantageously changes its spectral characteristics when an incident light transmits through the optical low pass filter depending on an angle (angle of incidence) with which the incident light enters the optical low pass filter.

For example, it is assumed that a digital camera having a mechanism in which a light passes through a high magnification lens or similar lens, and then enters an optical low pass filter. In this case, an incident light, which comes from the center portion of the lens, enters the optical low pass filter with approximately right angle with respect to the principal surface of the optical low pass filter. On the other hand, an incident light, which comes from the peripheral portion of the lens, enters the optical low pass filter with being inclined with respect to the principal surface of the optical low pass filter. Thus, the incident lights with various angles of incidence transmit through the optical low pass filter. Therefore, the lights that have transmitted through the optical low pass filter have non-uniform spectral characteristics. Thus, the hue of taken image unfortunately has non-uniformity and variation.

A need thus exists for an optical component which is not susceptible to the drawback mentioned above.

### SUMMARY

An optical component according to a first aspect of the disclosure includes an optical substrate and a first band-pass filter disposed on the optical substrate. The first band-pass filter includes a high refractive index layer having a first refractive index, and a low refractive index layer having a second refractive index lower than the first refractive index. The high refractive index layer and the low refractive index layer are layered. An expression (n_{L}×d_{L})/(n_{H}×d_{H})≦0.50 . . . (1) is fulfilled, wherein the first refractive index is n_{H}, the second refractive index is the high refractive index layer has a physical film thickness of d_{H}, and the low refractive index layer has a physical film thickness of d_{L}.

### BRIEF DESCRIPTION OF THE DRAWINGS

The foregoing and additional features and characteristics of this disclosure will become more apparent from the following detailed description considered with reference to the accompanying drawings.

FIG. 1A is a cross-sectional view illustrating an optical low pass filter according to an embodiment of the disclosure.

FIG. 1B an enlarged view illustrating a part of the cross-sectional view of the optical low pass filter according to the embodiment.

FIG. 2 is a graph illustrating characteristics of a band-pass filter used in the optical low pass filter according to the embodiment.

FIG. 3 is a cross-sectional view of an optical low pass filter for illustrating a relation between the optical low pass filter and angles of incident lights.

FIG. 4A is a graph illustrating incident angle dependence of spectral characteristics of the optical low pass filter.

FIG. 4B is a graph illustrating the incident angle dependence of the spectral characteristics of the optical low pass filter.

FIG. 5 is a graph illustrating a relation between material refractive index ratios and incident angle dependence IR side half value shift amounts.

FIG. 6A is a schematic side view illustrating a relation between a lens and the optical low pass filter.

FIG. 6B is a schematic side view illustrating a dichroic mirror.

### DETAILED DESCRIPTION

### First Embodiment

### Configuration of Optical Low Pass Filter 100

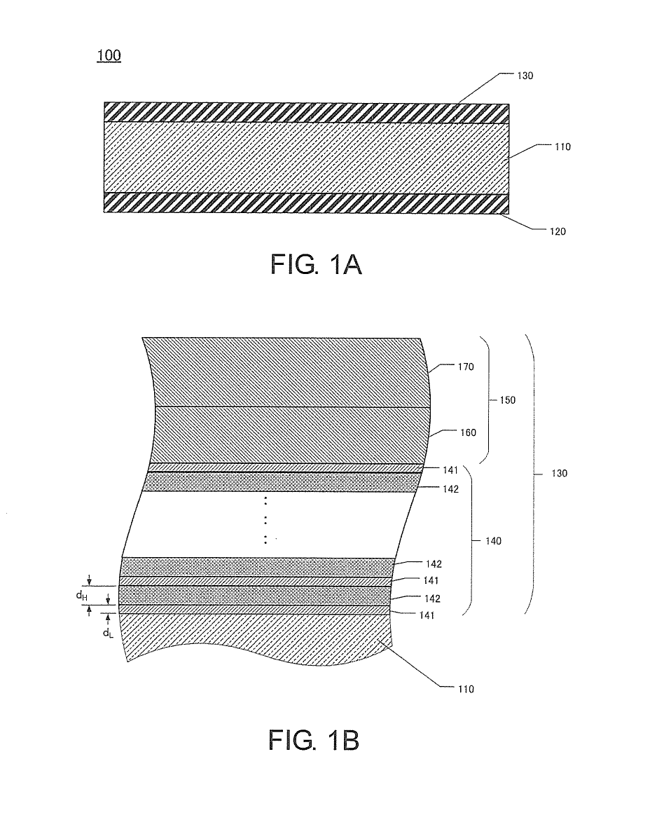

First, the following description describes an optical low pass filter 100 according to an embodiment of this disclosure with reference to FIGS. 1A and 1B. FIG. 1A is a cross-sectional view of the optical low pass filter 100. FIG. 1B an enlarged view illustrating a part of the cross-sectional view of the optical low pass filter 100.

The optical low pass filter 100 includes a plate-shaped optical substrate 110 as illustrated in FIG. 1A. The optical substrate 110 may use, for example, crystal, LiNbO₃, optical glass, or transparent resin such as plastic, depending on the application. Then, an anti-reflection film 120 is disposed on one of principal surfaces of the optical substrate 110. The anti-reflection film 120 can reduce the surface reflection of the optical low pass filter 100. The anti-reflection film 120 may include a layer of a mixed oxide mainly using, for example, titanium (Ti) and lanthanum (La).

In addition, a band-pass filter 130 is disposed on the opposite surface of the optical substrate 110. The opposite surface is the back surface of the surface on which the anti-reflection film 120 is disposed. The band-pass filter 130 reduces infrared rays and ultraviolet rays, and reduces the incident angle dependence of the spectral characteristics as described below.

The following description describes the configuration of the band-pass filter 130 with reference to FIG. 1B. The band-pass filter 130 includes a first band-pass filter 140 and a second band-pass filter 150. The first band-pass filter 140 is disposed on the surface of the optical substrate 110, and the second band-pass filter 150 is disposed on the surface of the first band-pass filter 140. The second band-pass filter 150 includes a second band-pass filter A portion 160 and a second band-pass filter B portion 170. The second band-pass filter A portion 160 is disposed on the surface of the first band-pass filter 140, and the second band-pass filter B portion 170 is disposed on the surface of the second band-pass filter A portion 160. Then, the second band-pass filter A portion 160 and the second band-pass filter B portion 170 reduce infrared rays and ultraviolet rays.

The first band-pass filter 140 has a configuration in which two types of thin layers are alternately layered. One of two types of thin layers is referred to as low refractive index layers 141 and the other one of two types of thin layers is referred to as high refractive index layers 142. One low refractive index layer 141 is disposed on the surface of the optical substrate 110. One high refractive index layer 142 is disposed on the surface of the low refractive index layer 141. Further, another low refractive index layer 141 is disposed on the surface of the high refractive index layer 142. In this way, the low refractive index layers 141 and the high refractive index layers 142 are alternately layered. Note that, although the first band-pass filter 140 in FIG. 1B includes the low refractive index layer 141 as a bottom layer and a top layer, the first band-pass filter 140 may include the high refractive index layer 142 as one of the bottom layer and the top layer, or as both of the bottom layer and the top layer.

When the refractive index of the low refractive index layer 141 is compared with the refractive index of the high refractive index layer 142, the refractive index of the low refractive index layer 141 is lower than the refractive index of the high refractive index layer 142. The low refractive index layer 141 includes, for example, SiO₂ as a material, while the high refractive index layer 142 includes, for example, TiO₂ as a material. Here, when the refractive index of the low refractive index layer 141 is “n_{L},” the physical film thickness of the low refractive index layer 141 is “d_{L},” the refractive index of the high refractive index layer 142 is “n_{H},” and the physical film thickness of the high refractive index layer 142 is “d_{H},” respective values are selected such that a material refractive index ratio (=(n_{L}×d_{L})/(n_{H}×d_{H})), which is an optical film thickness ratio between the low refractive index layer 141 and the high refractive index layer 142 fulfills a following expression (1).

(n_{L}×d_{L})/(n_{H}×d_{H})≦0.50 (1)

Also, the reflectivity R of the multilayer film can be expressed by the following expression (2).

R=((1−N)/(1+N))² (2)

where N=(n_{H}/n_{L})^{2p}×(n_{H}²/n_{S}), “n_{S}” is the refractive index of the optical substrate, and “p” is the layered number of the multilayer film. Although an optical low pass filter generally includes an evaporation material, whose refractive index “n_{L}” is “n_{L}≦1.6,” as the low refractive index layer, and an evaporation material, whose refractive index “n_{H}” is “n_{H}≧2.0,” as the high refractive index layer, the first band-pass filter 140 includes similar evaporation materials for the low refractive index layer 141 and the high refractive index layer 142. In addition, the layered number “p” is set to, for example, 30 layers.

For example, similar to the first band-pass filter 140, the second band-pass filter A portion 160 and the second band-pass filter B portion 170 have a configuration in which the low refractive index layers 141 and the high refractive index layers 142 are alternately layered. However, with being different from the first band-pass filter 140, the second band-pass filter A portion 160 and the second band-pass filter B portion 170 are formed such that a material refractive index ratio “(=(n_{L}×d_{L})/(n_{H}×d_{H})),” which is an optical film thickness ratio, is about 1.0, then a physical film thickness “d_{L}” and a physical film thickness “d_{H}” are adjusted to adjust a range of a transmission wavelength. Note that, a low refractive index layer and a high refractive index layer, which constitute the second band-pass filter A portion 160 and the second band-pass filter B portion 170, may not be configured with the materials similar to that of the first band-pass filter 140. Also, the second band-pass filter A portion 160 and the second band-pass filter B portion 170 may be configured with different materials each other.

In the optical low pass filter 100, the low refractive index layer 141 and the high refractive index layer 142 are formed on the optical substrate 110, which is prepared in advance, by ion assisted evaporation. Subsequently, the second band-pass filter A portion 160 and the second band-pass filter B portion 170 are similarly formed by the ion assisted evaporation. Note that, besides the ion assisted evaporation, a physical evaporation method such as EB (Electron Beam) evaporation, ion plating, or sputtering, or a chemical evaporation method such as CVD (Chemical Vapor Deposition) may be used.

### Spectral Characteristics of Optical Low Pass Filter 100

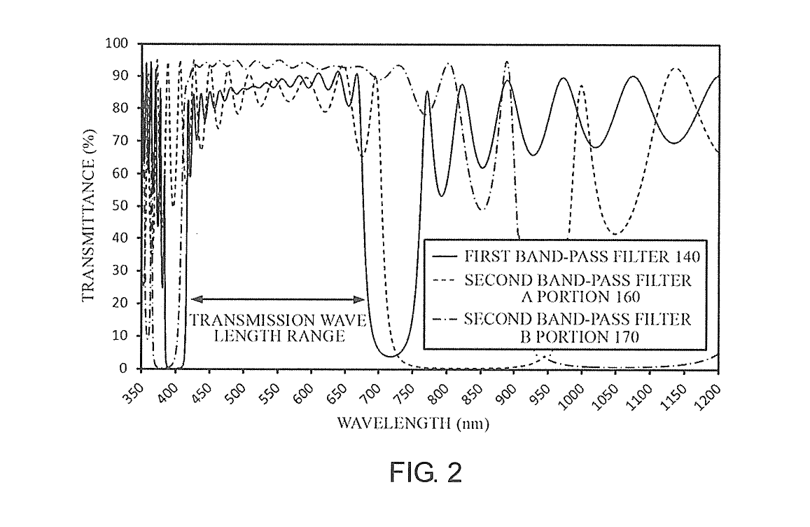

The following description describes the spectral characteristics of the band-pass filter 130, which is used in the optical low pass filter 100, with reference to FIG. 2.

FIG. 2 is a graph illustrating the characteristics of the band-pass filter 130 used in the optical low pass filter 100. The horizontal axis in FIG. 2 indicates the wavelength (nm) of incident lights entering respective band-pass filters. The vertical axis in FIG. 2 indicates the transmittance (%) of incident lights entering respective band-pass filters. In FIG. 2, the solid line shows the spectral characteristics of the first band-pass filter 140. In FIG. 2, the dashed line shows the spectral characteristics of the second band-pass filter A portion 160. In FIG. 2, the one dot chain line shows the spectral characteristics of the second band-pass filter B portion 170.

As illustrated in FIG. 2, the band-pass filter 130 can reduce infrared rays and ultraviolet rays by using the first band-pass filter 140, the second band-pass filter A portion 160, and the second band-pass filter B portion 170 in combination. For example, in FIG. 2, the transmittance of incident light remains high in the range of the wavelength from about 420 nm to about 680 nm (see “transmission wave length range” indicated by the arrow in FIG. 2).

### Incident Angle Dependency of Spectral Characteristics

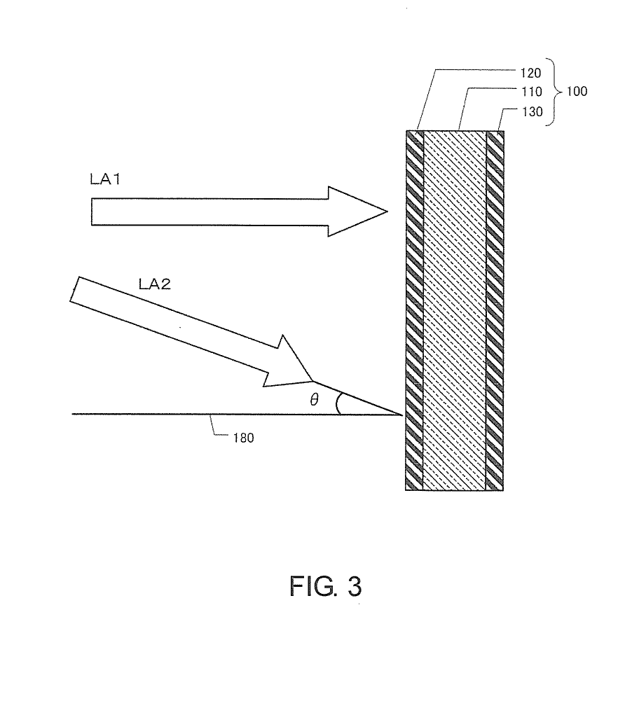

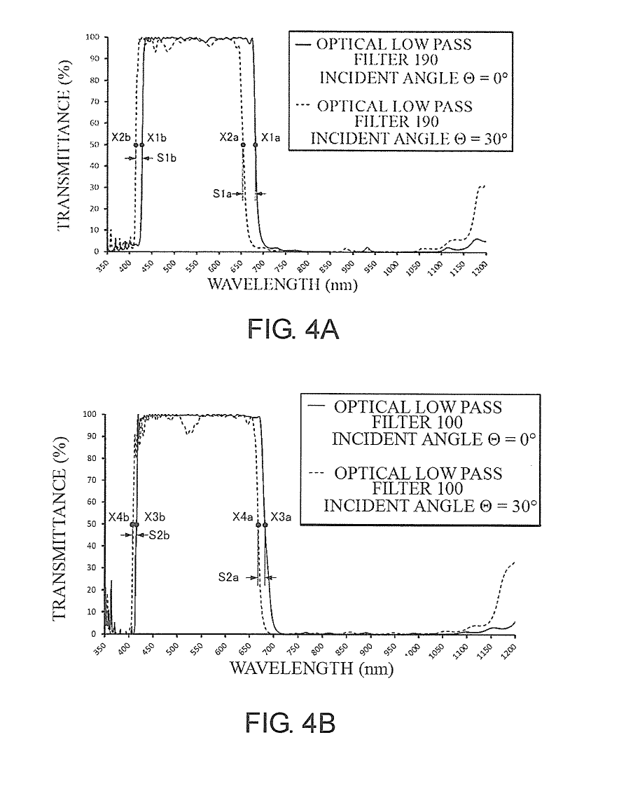

The band-pass filter varies the ranges of transmission wavelengths depending on differences in angles of incidence of lights entering the band-pass filter. Therefore, the optical low pass filter including the band-pass filter also varies the ranges of transmission wavelengths depending on differences in angles of incidence of lights entering the band-pass filter. The following description describes the incident angle dependence of the spectral characteristics of the optical low pass filter 100 with reference to FIG. 3, FIG. 4A, and FIG. 4B. A description will be given by comparing the optical low pass filter 100 with a conventional optical low pass filter 190 (not illustrated), which does not include the first band-pass filter 140.

FIG. 3 is a cross-sectional view of the optical low pass filter 100, which illustrates a relation between the optical low pass filter 100 and the angles of incident lights. In the following description, an angle of incidence θ of a light entering the optical low pass filter 100 is defined as an angle formed between a normal line 180 of the principal surface of the optical low pass filter 100 and an incident direction of the light. For example, as illustrated in FIG. 3, an incident light LA1 has an angle of incidence θ of 0°, since the incident light LA1 going along a direction perpendicular to the principal surface of the optical low pass filter 100. Also, an incident light LA2 has an angle of incidence θ of 30°, since the incident light LA2 going along a direction, which is tilted by an angle of 30° from the normal line 180 of the optical low pass filter 100. Although the incident lights enter the optical low pass filter 100 from the anti-reflection film 120 side surface in FIG. 3, the incident lights may enter from the band-pass filter 130 side surface.

FIG. 4A is a graph illustrating the incident angle dependence of the spectral characteristics of the optical low pass filter 190. In FIG. 4A, the horizontal axis indicates the wavelength (nm) of an incident light entering the optical low pass filter 190, while the vertical axis indicates the transmittance (%) of the incident light. Also, the solid line indicates the spectral characteristics of the incident light entering the optical low pass filter 190 with an angle of incidence θ of 0°. The dashed line indicates the spectral characteristics of the incident light entering the optical low pass filter 190 with an angle of incidence θ of 30°.

In the conventional optical low pass filter 190, the second band-pass filter 150 is directly disposed on the optical substrate 110 while the first band-pass filter 140 is not disposed. That is, the spectral characteristics of the optical low pass filter 190 illustrated in FIG. 4A mainly exhibits that of the second band-pass filter 150.

As illustrated in FIG. 4A, in the second band-pass filter 150, it is shown that transmission wave length range where the transmittance of a light having an angle of incidence of 30° becomes high shifts to wave length side lower than that of a light having angle of incidence θ of 0°, when the transmission wave length range where the transmittance of a light having an angle of incidence θ of 30° becomes high is compared with that of a light having an angle of incidence θ of 0°. Namely, in the second band-pass filter 150, the spectral characteristic of the incident light varies depending on the angle of incidence of the light. Assume that X1a is an infrared side wavelength of a light having an angle of incidence θ of 0° with the transmittance of the incident light being 50%, and X2a is an infrared side wavelength of a light having an angle of incidence θ of 30° with the transmittance of the incident light being 50%. X1a is about 682 nm, and X2a is about 654 nm. Therefore, when the transmittance of the incident light is 50%, the shift amount of the infrared (IR) side wavelength (incident angle dependence IR side half value shift amount) S1a is about 28 nm. Also, assume that X1b is an ultraviolet side wavelength of a light having an angle of incidence θ of 0° with the transmittance of the incident light being 50%, and when X2b is an ultraviolet side wavelength of a light having an angle of incidence θ of 30° with the transmittance of the incident light being 50%. X1b is about 428 nm, and X2b is about 414 nm. Therefore, when the transmittance of the incident light is 50%, the shift amount of the ultraviolet (UV) side wavelength (incident angle dependence UV side half value shift amount) S1b is about 14 nm.

As illustrated in FIG. 4A, the optical low pass filter 190 can maintain the transmittance in a visible light range, as well as remove both of ultraviolet rays and infrared rays with the combination of the second band-pass filter A portion 160 and the second band-pass filter B portion 170, which constitute the second band-pass filter 150. However, for example, a digital camera that includes such an optical low pass filter, disadvantageously has a large wavelength shift amount of an incident angle dependence transmittance, which does not ensure uniformed hue of taken images and causes the variation of the hue. Accordingly, it is desirable to have an optical low pass filter which can reduce a wavelength shift amount of an incident angle dependence transmittance.

FIG. 4B is a graph illustrating the incident angle dependence of the spectral characteristics of the optical low pass filter 100. In FIG. 4B, the horizontal axis indicates the wavelength (nm) of an incident light entering the optical low pass filter 100, while the vertical axis indicates the transmittance (%) of the incident light. Also, the solid line indicates the spectral characteristics of the incident light when the incident light enters the optical low pass filter 100 with angle of incidence θ of 0°. The dashed line indicates the spectral characteristics of the incident light when the incident light enters the optical low pass filter 100 with angle of incidence θ of 30°.

As illustrated in FIG. 4B, in the optical low pass filter 100, it is shown that transmission wave length range where the transmittance of a light having an angle of incidence θ of 30° becomes high shifts to wave length side lower than that of a light having angle of incidence θ of 0°, when the transmission wave length range where the transmittance of a light having an angle of incidence θ of 30° becomes high is compared with that of a light having an angle of incidence θ of 0°. Assume that X3a is an infrared side wavelength of a light having an angle of incidence θ of 0° with the transmittance of the incident light being 50%, and X4a is an infrared side wavelength of a light having an angle of incidence θ of 30° with the transmittance of the incident light being 50%. X3a is about 681 nm, and X4a is about 667 nm. Therefore, when the transmittance of the incident light is 50%, the shift amount of the infrared side wavelength (incident angle dependence IR side half value shift amount) S2a is about 14 nm. Also, assume that X3b is an ultraviolet side wavelength of a light having an angle of incidence θ of 0° with the transmittance of the incident light being 50%, and X4b is an ultraviolet side wavelength of a light having an angle of incidence θ of 30° with the transmittance of the incident light being 50%. X3b is about 415 nm, and X4b is about 408 nm. Therefore, when the transmittance of the incident light is 50%, the shift amount of the ultraviolet (UV) side wavelength (incident angle dependence UV side half value shift amount) S2b is about 7 nm.

Accordingly, it can be seen that the variation of the spectral characteristics of the optical low pass filter 100 illustrated in FIG. 4B is about half of the variation of the spectral characteristics of the conventional optical low pass filter 190 illustrated in FIG. 4A. Here, a point of difference between the optical low pass filter 100 and the conventional optical low pass filter 190 is that whether the first band-pass filter 140 is included or not. And, with the first band-pass filter 140, the variation of the spectral characteristics of the optical low pass filter 100 may be reduced to about half as described above. Namely, the first band-pass filter 140 lowers the incident angle dependence of the spectral characteristics of the optical low pass filter 100.

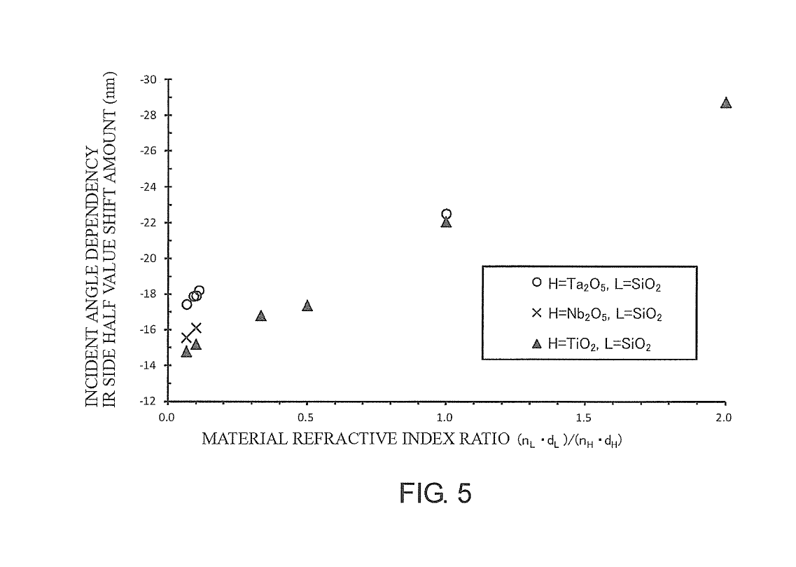

FIG. 5 is a graph illustrating a relation between the refractive index ratios and the incident angle dependence IR side half value shift amounts of materials. The following description describes a relation between the conditions of the low refractive index layer 141 and the high refractive index layer 142, which constitute the first band-pass filter 140, and the incident angle dependence of the spectral characteristics of the first band-pass filter 140 with reference to FIG. 5. FIG. 5 illustrates the above-described relation when SiO₂ is used for the low refractive index layer 141 (illustrated as “L” in FIG. 5), and Ta₂O₅ (symbol “◯” in FIG. 5), an Nb₂O₅ (symbol “x” in FIG. 5), or a TiO₂ (symbol “▴” in FIG. 5) are used for the high refractive index layer 142 (illustrated as “H” in FIG. 5). Also, in FIG. 5, the horizontal axis indicates the material refractive index ratio (=(n_{L}×d_{L})/(n_{H}×d_{H})), and the vertical axis indicates the incident angle dependence IR side half value shift amount (nm). The incident angle dependence IR side half value shift amount (nm) indicated by the vertical axis in FIG. 5 is a value obtained by subtracting a wavelength of a light having an angle of incidence θ of 0° from a wavelength of a light having an angle of incidence θ of 30°. That is, if the value is positive, a shift from the wavelength of a light having angle of incidence θ of 0° to the wavelength of a light having angle of incidence θ of 30° directs to the infrared side, while if the value is negative, the shift directs to the ultraviolet side. In FIG. 5, the vertical axis indicates the negative values, accordingly all shifts, in FIG. 5, from the wavelength of a light having angle of incidence θ of 0° to the wavelength of a light having angle of incidence θ of 30° direct to the ultraviolet side.

FIGS. 4A and 4B indicate measured values, while the fragments of data in FIG. 5 are theoretical values of an incident angle dependence IR side half value shift amount with respect to a material refractive index ratio obtained with arbitrarily changing a rate (ddd_{H}) between the physical film thickness of the high refractive index layer d_{H} and the physical film thickness of the low refractive index layer d_{L}. Therefore, for example, FIG. 4A illustrates that the IR side half value shift amount is about 28 nm when a material refractive index ratio of TiO₂ (“▴” in FIG. 5) is 1.0, while FIG. 5 illustrates that an IR side half value shift amount is about 22 nm. The actual optical low pass filters such as those illustrated in FIGS. 4A and 4B tend to exhibit the measured values of the incident angle dependence IR side half value shift amounts lager than the theoretical values, because they include an adjusting layer for, for example, removing ripples in transmittance caused by variation in wavelength of an incident light.

In FIG. 5, in each film configuration, the absolute value of the incident angle dependence IR side half value shift amount decreases as the material refractive index ratio decreases. In addition, the refractive index of a silicon dioxide (SiO₂) is 1.46; the refractive index of a titanium dioxide (TiO₂) is 2.4; the refractive index of a niobium pentoxide (Nb₂O₅) is 2.25; the refractive index of a tantalum pentoxide (Ta₂O₅) is 2.1. When the refractive indexes of respective film configurations are compared near the material refractive index ratio of 1.0, the refractive index n_{H} of the high refractive index layer 142 has the largest value. Then, the combination of a titanium dioxide (TiO₂) and a silicon dioxide (SiO₂), which has the largest rate n_{H}/n_{L} between the refractive index n_{H} of the high refractive index layer 142 and the refractive index n_{L} of the low refractive index layer 141, exhibits the smallest absolute value of the incident angle dependence IR side half value shift amount. In addition, the refractive index n_{H} of the high refractive index layer 142 has the smallest value, then a combination of a tantalum pentoxide (Ta₂O₅) and a silicon dioxide (SiO₂), which has the smallest rate n_{H}/n_{L} between the refractive index n_{H} of the high refractive index layer 142 and the refractive index n_{L} of the low refractive index layer 141, exhibits the largest absolute value of the incident angle dependence IR side half value shift amount. Namely, the materials constituting the first band-pass filter 140 are preferably selected such that the refractive index n_{H} of the high refractive index layer 142 has a large value, and the rate n_{H}/n_{L} between the refractive index n_{H} of the high refractive index layer 142 and the refractive index n_{L} of the low refractive index layer 141 has a large value.

As illustrated in FIG. 5, it is more preferred that the materials have more decreased material refractive index ratio, since the incident angle dependence IR side half value shift amount decreases as the material refractive index ratio decreases. In particular, the material refractive index ratio is preferably equal to or less than 0.5 as illustrated in expression (1). When the material refractive index ratio is 0.5, the incident angle dependence IR side half value shift amount is about 18.5 (nm) if TiO₂ (“▴” in FIG. 5) is used. When the incident angle dependence IR side half value shift amount is equal to or less than 18.5 (nm), the hue of an image taken by, for example, a digital camera for practical use is less problematic. It is considered that problems such as the hue of an image can be sufficiently improved even if the incident angle dependence IR side half value shift amount slightly increases in actual products, which includes an adjusting film. Also, the material refractive index ratio of 0.5 can be sufficiently achieved in the fabrication processes.

In addition, the material refractive index ratio is more preferably equal to or less than 0.2. When the material refractive index ratio is 0.2, which is challenging in the fabrication processes, the incident angle dependence IR side half value shift amount becomes about 15 (nm) if TiO₂ (“▴” in FIG. 5) is used, which can satisfy the requirement of customers for a high-quality optical low pass filter.

The optical low pass filter 100 in accordance with this disclosure is not limited to the configurations illustrated in the above-described embodiments. It is possible to make, for example, following embodiments with appropriately changing the above-described embodiments.

The optical low pass filter 100 may include Al₂O₃ or La₂O₃ as the low refractive index layer 141, instead of SiO₂. They both have n_{L}≦1.6. Also, the optical low pass filter 100 may further include an anti-static film disposed on the surface thereof, and an MgF₂ film as an anti-reflection film disposed on the surface of the band-pass filter 130.

Also, in the above-described embodiment, the optical low pass filter 100 includes the anti-reflection film 120. However, without the anti-reflection film 120, the optical low pass filter 100 can reduce the incident angle dependence of the spectral characteristics with the first band-pass filter 140.

Also, in the above-described embodiment, the refractive indexes are selected such that “n_{H}≧2.0” and “n_{L}≦1.6.” However, as illustrated in FIG. 5, fulfilling “(n_{L}×d_{L})/(n_{H}×d_{H})≦0.50” can reduce the incident angle dependence of the spectral characteristics.

Also, in the above-described embodiment, the optical low pass filter 100 includes the second band-pass filter 150. The second band-pass filter 150, then, reduces infrared rays and ultraviolet rays that transmits through the optical low pass filter 100. However, the second band-pass filter 150 may reduce only infrared rays. Also, the second band-pass filter 150 may reduce only ultraviolet rays. Also, the second band-pass filter 150 may reduce lights having the predetermined wavelength depending on the usage.

Also, in the above-described embodiment, the first band-pass filter 140 is disposed on the surface of the optical substrate 110. However, the first band-pass filter 140 may be disposed on the surface of the second band-pass filter B portion 170, or may be disposed between the second band-pass filter A portion 160 and the second band-pass filter B portion 170.

### Second Embodiment

The optical low pass filter 100 can be applied to electronic equipment such as a digital camera. Also, the configuration of the first band-pass filter 140, which reduces the incident angle dependence IR side half value shift amount, may be used in optical components other than the optical low pass filter. The following description describes a usage example of the optical low pass filter 100, as well as an application example of the first band-pass filter 140.

### Example of Optical Low Pass Filter 100 Applied to Electronic Equipment

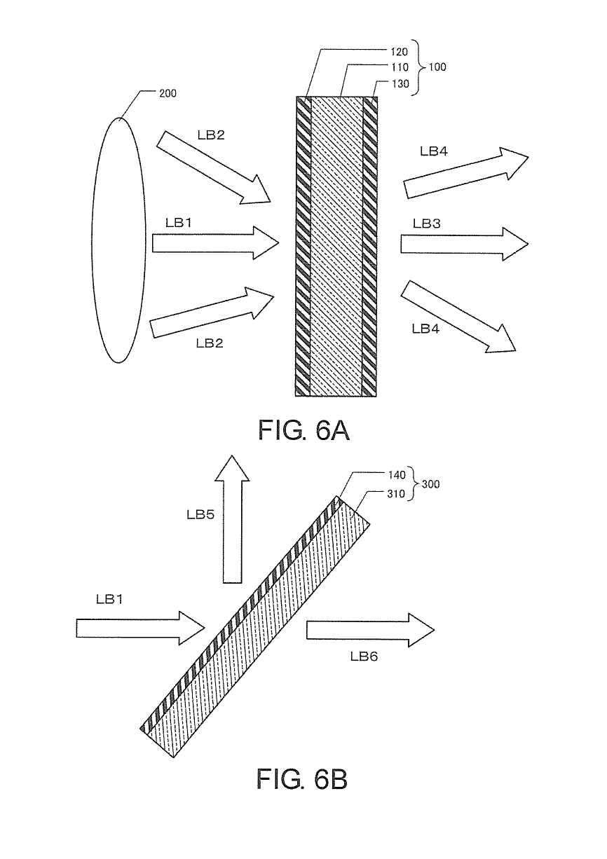

FIG. 6A is a view illustrating a relation between a lens 200 and the optical low pass filter 100. The following description describes an example in which the optical low pass filter 100 is applied to electronic equipment such as a digital camera with reference to FIG. 6A.

When the optical low pass filter 100 is applied to a digital camera or similar equipment, the lens 200 is disposed on one side of the principal surfaces of the optical low pass filter 100 as illustrated in FIG. 6A. Note that, the lens 200 is a convex lens. Also, a sensor (not illustrated) is disposed on the other side of the principal surfaces of the optical low pass filter 100. Lights that transmit through the lens 200 enter the optical low pass filter 100 as incident lights LB1 and LB2 or similar lights, which are illustrated in FIG. 6A, then transmit through the optical low pass filter 100 to reach the above-described sensor as transmitted lights LB3 and LB4 or similar light to be detected by the sensor.

In this application example, the incident light LB1 comes from the center portion of the lens 200, and enters the optical low pass filter 100 with an angle of incidence of 0° as illustrated in FIG. 6A. On the other hand, the incident light LB2 comes from a position that is apart from the center portion of the lens 200, and enters the optical low pass filter 100 with an angle of incidence, which is larger than the angle of incidence of 0°, as illustrated in FIG. 6A.

Here, the optical low pass filter 100 is one with the reduced incident angle dependence of the spectral characteristics as described above. Thus, differences between the spectral characteristics of the incident light LB1 and the spectral characteristics of the incident light LB2 are small. Accordingly, variations of the hue are reduced when transmitted lights LB3 and LB4 are detected by the above-described sensor.

### Effect

In the optical system illustrated in FIG. 6A, the optical low pass filter 100 fulfills the condition in which “(n_{L}×d_{L})/(n_{H}×d_{H})” is equal to or less than 0.5. Accordingly, the optical system illustrated in FIG. 6A can sufficiently reduce the incident angle dependence of the spectral characteristics. As illustrated in FIG. 6A, when the optical low pass filter 100 is applied to, for example, the digital camera, the optical low pass filter 100 can avoid possible problem of the hue of an image taken for practical use.

### Configuration of Dichroic Mirror 300

FIG. 6B is a schematic side view illustrating a dichroic mirror 300. FIG. 6B illustrates the incident light LB1 entering the dichroic mirror 300. The dichroic mirror 300 includes a mirror base material 310 and the first band-pass filter 140. The mirror base material 310 is formed of a multilayered film of dielectric materials having different refractive indexes. The first band-pass filter 140 is disposed on the surface of the mirror base material 310 where the incident light LB1 enters. The incident light LB1 is divided into a reflected light LB5 and a transmitted light LB6 by the dichroic mirror 300. The reflected light LB5 is reflected by the dichroic mirror 300, while the transmitted light LB6 transmits through the dichroic mirror 300.

If a dichroic mirror is used for a diverging light beam, an angle of incidence will change depending on an incident position of the light, which may vary the spectral characteristics. With the first band-pass filter 140, the dichroic mirror 300 can preferably reduce the variation of the spectral characteristics caused by an angle of incidence.

Above all, the preferred embodiments of this disclosure are described in detail. It is apparent to those skilled in the art that a variety of variation and modification of the embodiment can be made within the technical scope of this disclosure. Also, the various combinations of the features of respective embodiments can be made.

Also, the application example of the band-pass filter 130 or the first band-pass filter 140 can be applied to other various optical components in the optical low pass filter and the dichroic mirror. For example, the band-pass filter 130 or the first band-pass filter 140 may be disposed on the surface of a lens, a window plate, or a prism. In this case, the band-pass filter 130 or the first band-pass filter 140 can be disposed on an incident surface, an emission surface, or both of an incident surface and an emission surface of these optical components. Also, the band-pass filter 130 or the first band-pass filter 140 may be used for preventing wavelength shifts in the optical communications. In this case, the range of transmission region of the band-pass filter 130 or the first band-pass filter 140 is appropriately adjusted.

In the optical component according to the first aspect, an optical component according to a second aspect may be configured as follows. The high refractive index layer is formed of a material with a refractive index of equal to or more than 2.0, and the low refractive index layer is formed of a material with a refractive index of equal to or less than 1.6.

In the optical component according to the first or the second aspect, an optical component according to a third aspect may be configured as follows. The high refractive index layer is formed of a thin film of TiO₂, Nb₂O₅, or Ta₂O₅, and the low refractive index layer is formed of a thin film of Al₂O₃, SiO₂, or La₂O₃.

In the optical component according to anyone of the first to the third aspect, an optical component according to a fourth aspect may be configured as follows. The first band-pass filter includes a plurality of the high refractive index layers and a plurality of the low refractive index layers, and the high refractive index layers and the low refractive index layers are alternately layered one another.

In the optical component according to any one of the first to the fourth aspect, an optical component according to a fifth aspect may further include a second band-pass filter including: a band-pass filter configured to remove an ultraviolet ray, a band-pass filter configured to remove an infrared ray, or a band-pass filter configured to remove an ultraviolet ray and an infrared ray.

In the optical component according to anyone of the first to the fifth aspect, an optical component according to a sixth aspect may be configured as follows. The first band-pass filter has a shift amount of a light having an angle of incidence of 30° with respect to a light having an angle of incidence of 0°, and the shift amount is equal to or less than 18.5 nm at an infrared side wavelength having a light transmittance of 50%.

In the optical component according to any one of the first to the sixth aspect, an optical component according to a seventh aspect may be configured as follows. The optical substrate is a lens, a window plate, or a prism. The lens, the window plate, and the prism are each formed of glass, crystal, or plastic, and the first band-pass filter is disposed on an incident surface, an emission surface, or both of the incident surface and the emission surface of the optical substrate.

In the optical component according to any one of the first to the sixth aspect, an optical component according to an eighth aspect may be configured as follows. The optical substrate is a dichroic mirror, and the first band-pass filter is disposed on an incident surface of the optical substrate.

The optical component according to the disclosure reduces the difference between the spectral characteristics of the incident light and the spectral characteristics of the transmitted light, thus ensuring the reduced incident angle dependence of spectral characteristics.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An optical component, comprising:
an optical substrate; and
a first band-pass filter, disposed on the optical substrate, wherein
the first band-pass filter includes: a high refractive index layer having a first refractive index, and a low refractive index layer having a second refractive index lower than the first refractive index, the high refractive index layer and the low refractive index layer being layered, and
an expression (n_{L}×d_{L})/(n_{H}×d_{H})≦0.50 (1) is fulfilled,
wherein the first refractive index is n_{H}, the second refractive index is n_{L}, the high refractive index layer has a physical film thickness of d_{H}, and the low refractive index layer has a physical film thickness of d_{L}.

2. The optical component according to claim 1, wherein
the high refractive index layer is formed of a material with a refractive index of equal to or more than 2.0, and
the low refractive index layer is formed of a material with a refractive index of equal to or less than 1.6.

3. The optical component according to claim 1, wherein
the high refractive index layer is formed of a thin film of TiO₂, Nb₂O₅, or Ta₂O₅, and
the low refractive index layer is formed of a thin film of Al₂O₃, SiO₂, or La₂O₃.

4. The optical component according to claim 1, wherein
the first band-pass filter includes a plurality of the high refractive index layers and a plurality of the low refractive index layers, and
the high refractive index layers and the low refractive index layers are alternately layered one another.

5. The optical component according to claim 1, further comprising:
a second band-pass filter including: a band-pass filter configured to remove an ultraviolet ray, a band-pass filter configured to remove an infrared ray, or a band-pass filter configured to remove an ultraviolet ray and an infrared ray.

6. The optical component according to claim 1, wherein
the first band-pass filter has a shift amount of a light having an angle of incidence of 30° with respect to a light having an angle of incidence of 0°,
and the shift amount is equal to or less than 18.5 nm at an infrared side wavelength having a light transmittance of 50%.

7. The optical component according to claim 1, wherein
the optical substrate is a lens, a window plate, or a prism, and
the lens, the window plate, and the prism are each formed of glass, crystal, or plastic, and
the first band-pass filter is disposed on an incident surface, an emission surface, or both of the incident surface and the emission surface of the optical substrate.

8. The optical component according to claim 1, wherein
the optical substrate is a dichroic mirror, and
the first band-pass filter is disposed on an incident surface of the optical substrate.
